(19) United States
(12) Patent Application Publication
(10) Pub. No.: US 2006/0223439 A1
(43) Pub. Date: Oct. 5, 2006

(54) Wireless repeater assembly

(75) Inventors: Stephane Pinel, Atlanta, GA (US); Joy Laskar, Marietta, GA (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 11/394,911

(22) Filed: Mar. 31, 2006

Related U.S. Application Data
(60) Provisional application No. 60/666,839, filed on Mar. 31, 2005.
(60) Provisional application No. 60/666,840, filed on Mar. 31, 2005.
(60) Provisional application No. 60/667,287, filed on Apr. 1, 2005.
(60) Provisional application No. 60/667,312, filed on Apr. 1, 2005.
(60) Provisional application No. 60/667,313, filed on Apr. 1, 2005.
(60) Provisional application No. 60/667,375, filed on Apr. 1, 2005.
(60) Provisional application No. 60/667,443, filed on Apr. 1, 2005.
(60) Provisional application No. 60/667,458, filed on Apr. 1, 2005.

(51) Int. Cl. H04B 7/15

(52) U.S. Cl. 455/11.1

(57) ABSTRACT

A wireless repeater assembly is described. The wireless repeater assembly includes a receiver for receiving wireless data communications, wherein the receiver includes a receiving antenna for receiving analog signals; a receiver filter adapted to enable frequencies of a predetermined range to pass onto a receiver amplifier; and the receiver amplifier for boosting a signal emitted from the receiver filter; a transmitter for transmitting wireless data communications, wherein the transmitter includes a transmitter amplifier for boosting a signal coming from the receiver; a transmitter filter adapted to enable frequencies of a predetermined range to pass onto the transmitting antenna; and a transmitting antenna for transmitting signals from the repeater assembly; and a hard wire connection between the receiver and the transmitter, wherein the receiver and the transmitter are in wired communication. The wireless repeater assembly can operate at approximately 60 GHz.

### CROSS-REFERENCE TO RELATED APPLICATIONS

This application claims the benefit of U.S. Provisional Application Nos. 60/666,839 and 60/666,840, both filed 31 Mar. 2005, and U.S. Provisional Application Nos. 60/667,287, 60/667,312, 60/667,313, 60/667,375, 60/667,443, and 60/667,458, collectively filed 01 Apr. 2005, the entire contents and substance of which are hereby incorporated by reference.

### BACKGROUND OF THE INVENTION

1. Field of the Invention

The present invention relates to communication networks and, more particularly, to a wireless repeater that includes a receiver and a transmitter in an ultra-high speed personal area network.

2. Description of Related Art

As the world becomes more reliant on electronic devices, and portable devices, the desire for faster and more convenient devices continues to increase. Accordingly, manufacturers and designers of such devices strive to create faster and easier to use devices to serve the needs of consumers.

Indeed, the demand for ultra-high data rate wireless communication has increased, in particular due to the emergence of many new multimedia applications. Due to limitations at these high data rates, the need for ultrahigh speed personal area networking (PAN) and point-to-point or point-to-multipoint data links becomes vital.

Previously, conventional wireless local area networks (WLAN), e.g., 802.11a, 802.11b, and 802.11g standards, are limited, in the best case, to a data rate of only 54 Mb/s. Other high speed wireless communications, such as ultra wide band (UWB) and multiple-input/multiple-output (MIMO) systems can extend the data rate to 100 Mb/s.

To push through the gigabit per second (Gb/s) spectrum, either spectrum efficiency or the available bandwidth must be increased. Consequently, the recent development of technologies and systems operating at the millimeter-wave (MMW) frequencies increases with the demand to reach such data speeds.

Fortunately, many governments have made available several GHz (gigahertz) band-width unlicensed Instrumentation, Scientific, and Medical (ISM) bands in the 60 GHz spectrum. For instance, the United States, through the Federal Communications Commission (FCC), allocated 59-64 GHz for unlicensed applications in the United States. Likewise, Japan allocated 59-66 GHz for high speed data communications. Also, Europe allocated 59-62, 62-63, and 65-66 GHz for mobile broadband and WLAN communications. The availability of frequencies in this spectrum presents an opportunity for ultra-high speed short-range wireless communications.

Unfortunately, even with the advantages of high frequencies, there are some fundamental disadvantages. For example, one fundamental limitation of 60 GHz high-speed indoor communication systems is channel degradation due to the shadowing effect occurring with a line of sight (LOS) obstruction, often by a human body. For instance, if an individual or other object interferes with the transmission of the communication system, by simply entering the line of sight between, for example, a transmitter and a receiver, the communication signal can either fade, or be temporarily completely lost. Thus, the best transmission can be achieved in a direct LOS relationship.

What is needed, therefore, is a device and system to enable easy and non-obstructive LOS for efficient and convenient transmission of ultra-high frequencies at ultra-high data transmissions. It is to such a device that the present invention is primarily detected.

### BRIEF SUMMARY OF THE INVENTION

The present invention is a wireless repeater assembly for ultra-high speed wireless communications. The wireless repeater assembly includes a first antenna in communication with a receiver, and a second antenna in communication with a transmitter.

The receiver and the transmitter of the repeater can be mounted on an automated mechanical scanning system, or feature electronic scanning capabilities. Thus, the repeater can automatically perform alignment with strategically positioned base stations.

Alternatively, a multi-sector repeater can comprise N receiver/transmitters providing sectorial coverage, and thus alleviate many needs of the scanning features.

Preferably, the first antenna and the second antenna of the repeater can operate in the range of approximately 60 GHz, i.e., 54 to 66 GHz, wherein receiving and transmitting data communication at least approximately 5 Gb/s.

The present invention provides strategically positioned repeaters to minimize loss of sight problems for the repeater to communication with other receivers and transmitters in proximity to the repeater.

A wireless repeater assembly can comprise a receiver for receiving wireless data communications, wherein the receiver comprises: a receiving antenna for receiving analog signals; a receiver filter adapted to enable frequencies of a predetermined range to pass onto the receiver amplifier; and a receiver amplifier for boosting a signal emitted from the receiver filter; a transmitter for transmitting wireless data communications, wherein the transmitter comprises: a transmitter amplifier for boosting a signal coming from the receiver; a transmitter filter adapted to enable frequencies of a predetermined range to pass onto the transmitting antenna; and transmitting antenna for transmitting signals from the repeater assembly; and a hard wire connection between the receiver and the transmitter, wherein the receiver and the transmitter are in wired communication.

The receiving antenna can be tuned to receive approximately 60 GHz and the transmitting antenna is tuned to transmit at approximately 60 GHz.

The receiving antenna can comprise a high gain antenna, the receiver filter can comprise a band-pass filter, and wherein the receiver amplifier can comprise a low noise amplifier. The transmitter amplifier can comprise a power amplifier, the transmitter filter can comprise a band-pass filter, and wherein the transmitting antenna can comprise a high gain antenna.

The wireless repeater can further comprise a buffer memory positioned between the receiver and the transmitter for securing data.

The receiver can further comprise an analog-to-digital converter, and the transmitter further can comprise a digital-to-analog converter.

The wireless repeater assembly can comprise at least two layers, a top layer and a bottom layer, and wherein the top layer comprises liquid crystal polymer and the bottom layer comprises fire resistant 4.

The wireless repeater can be in communication with a power adapter of a light source, and wherein the wireless repeater assembly obtains operating power from the power adapter. Additionally, the wireless repeater assembly can be positioned at least two meters above a ground.

The wireless repeater assembly can transmit through a wall to a second wireless repeater assembly, and the wireless repeater assembly and the second wireless repeater assembly are in proximity to each other on opposing sides of the wall.

The wireless repeater can scan approximately 90 degrees in an azimuth, and in the range of approximately 90 to 180 degrees in a elevation for analog signals operating at approximately 60 GHz within five meters of the wireless repeater assembly. The wireless repeater assembly is preferably powered with direct current.

These and other objects, features and advantages of the present invention will become more apparent upon reading the following specification in conjunction with the accompanying drawing figures.

### BRIEF DESCRIPTION OF THE DRAWINGS

FIG. 1 depicts a wireless repeater assembly, in accordance with a preferred embodiment of the present invention.

FIG. 2 depicts another embodiment of the wireless repeater assembly, in accordance with a preferred embodiment of the present invention.

FIG. 3 depicts a unit to unit communication scheme using the wireless repeater assembly, in accordance with a preferred embodiment of the present invention.

FIG. 4 depicts a unit to unit docking system using the wireless repeater assembly, in accordance with a preferred embodiment of the present invention.

FIG. 5 depicts pyramidal multi-sector antenna, in accordance with a preferred embodiment of the present invention.

FIG. 6 depicts many illustrations of positioning of the wireless repeater assembly, in relationship to another transmitter and receiver, in accordance with a preferred embodiment of the present invention.

FIG. 7 depicts a wireless repeater environment, illustrating the angles of transmission/receiving data communication, in accordance with a preferred embodiment of the present invention.

FIG. 8 depicts a power adapter assembly for the wireless repeater assembly, in accordance with a preferred embodiment of the present invention.

FIG. 9 depicts an exemplary embodiment of positioning the power adaptor for the wireless repeater assembly, in accordance with a preferred embodiment of the present invention.

FIG. 10 depicts a wireless through-wall repeater assembly, in accordance with a preferred embodiment of the present invention.

### DETAILED DESCRIPTION OF THE INVENTION

To facilitate an understanding of the principles and features of the invention, it is explained hereinafter with reference to its implementation in an illustrative embodiment. In particular, the invention is described in the context of being a wireless repeater assembly enabling the repetition of communication signals and, further, to extend the range of wireless transmitters.

The invention, however, is not limited to its use as a wireless repeater assembly for ultra-high speed communications. Rather, the invention can be used when a repeater is desired, or as is necessary. Thus, the device described hereinafter as a wireless repeater can also find utility as a device for other applications, beyond that of a wireless repeater.

Additionally, the material described hereinafter as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

While the invention is described as operating within a preferred frequency range, one skilled in the art would appreciate that the repeater assembly can operate at most available frequencies. Additionally, while the invention is described as operating with range of a preferred data transmission speed, one skilled in the art would appreciate that the repeater assembly can operate at most data transmission speeds.

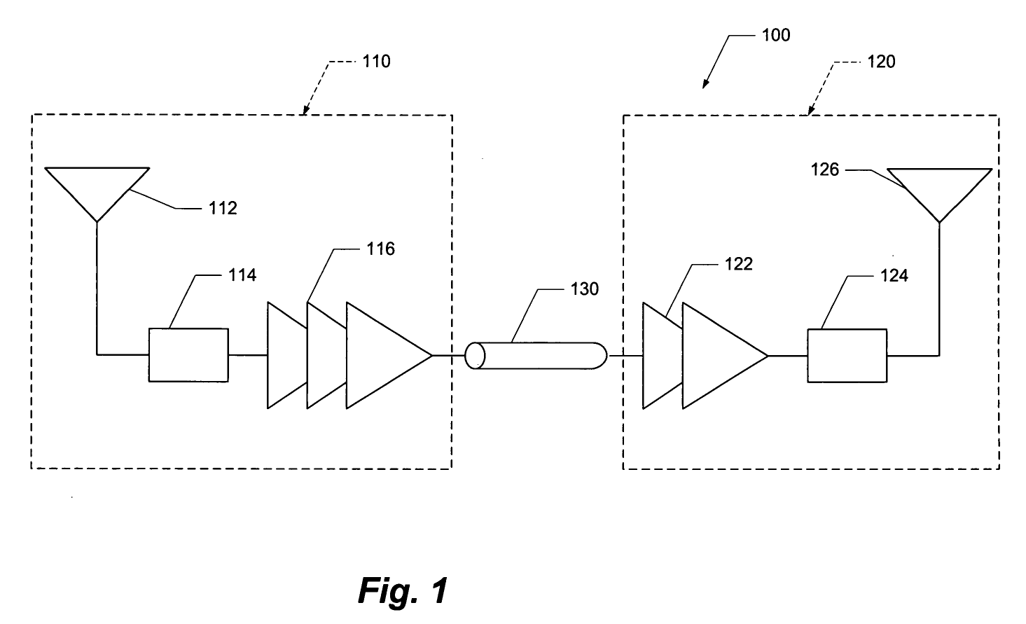

FIG. 1 illustrates a wireless repeater assembly 100 for repeating communication signals and extending the range of wireless transmitters. The wireless repeater assembly 100 comprises a receiver 110, and a transmitter 120. The receiver 110 can include an antenna 112, a filter 114, and an amplifier 116. The receiver 110 of the repeater assembly 100 can be adapted to receive signals transmitting at a particular frequency. The transmitter 120 can include an amplifier 122, a filter 124, and an antenna 126. The transmitter 120 of the repeater assembly 100 can be adapted to transmit signals at a particular frequency.

In a preferred embodiment, the receiver 110 and the transmitter 120 of the repeater assembly 100 are in communication. Indeed, preferably, the receiver 110 and transmitter 120 are in communication via a hard wire connection 130.

The receiver 110 includes the antenna 112. Preferably, the antenna 112 is adapted to receive frequencies in the range of approximately 60 GHz, i.e., 54 to 66 GHz. The antenna 112 can be a high gain antenna, which is an antenna having a focused, narrow radiowave beam width. The narrow beam width can allow for precise targeting of obtaining a signal. The high gain antenna is sometimes also referred to as a directional antenna. Medium gain antennas, exhibiting broader radiation coverage, preferably, can be used in a multi-sector embodiment.

The receiver 110 further includes the filter 114. Preferably, the filter 114 is a band-pass filter. Typically, a band-pass filter can be an electronic circuit that permits frequencies through, filtering a certain range. A preferred band-pass filter, for instance, would enable frequencies in the range of 54 to 66 GHz to pass, while the frequencies outside the set range are attenuated or dumped.

The receiver 110 can further include the amplifier 116. The amplifier 116, preferably, is a low noise amplifier. The low noise amplifier can provide a boost, or increase the gain, of a signal having been filtered by the filter 114, without degrading a signal to noise ratio.

The transmitter 120 includes the amplifier 122. Preferably, the amplifier 122 is a power amplifier. The power amplifier can boost a signal, wherein producing a larger load.

The transmitter 120 also includes a filter 124. The filter 124, in a preferred embodiment, can be a band-pass filter.

The transmitter 120, further, includes the antenna 126. Like the antenna 112 for the receiver 110, the antenna 126 for the transmitter 120, is preferably a high gain antenna, wherein adapted to transmit a signal from the repeater assembly 100.

In a preferred embodiment of the present invention, the repeater assembly 100 can receive and transmit, through the receiver 110 and the transmitter 120, respectively, in a range of 54 to 66 GHz. Typically, this range, i.e., approximately 60 GHz, includes devices that are used in short-range applications.

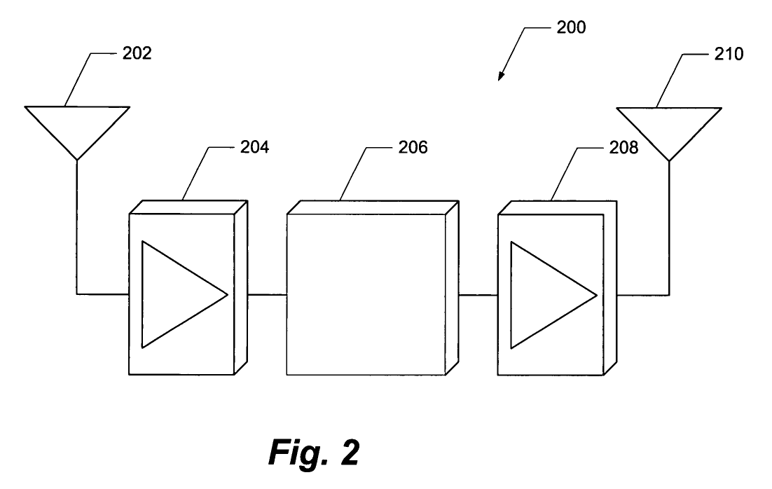

FIG. 2 illustrates another repeater assembly 200. A repeater assembly 200 is illustrated. The repeater assembly 200 comprises a receiver antenna 202, a receiver 204, a buffer memory device 206, a transmitter 208, and a transmitter antenna 210.

The receiver antenna 202 operates similar to the antenna 112, as described above. The receiver antenna 202 is in communication with the receiver 204. The receiver 204 can include an ADC, or an analog to digital converter. The ADC converts signals from analog into digital signals. The analog signal obtained from the receiver antenna 202 is converted to a digital signal. Preferably, the receiver 204 can operate at approximately 60 GHz.

The buffer memory device 206 can be adapted to contain data, especially when the receiver 204 is communicating with the transmitter 208. Preferably, the transmitter 208 includes a DAC, or digital to analog converter. The DAC converts digital signals into analog signals, wherein the repeater 200 can transmit the digital signal via the transmitter antenna 210. The transmitter 208 can operate at approximately 60 GHz.

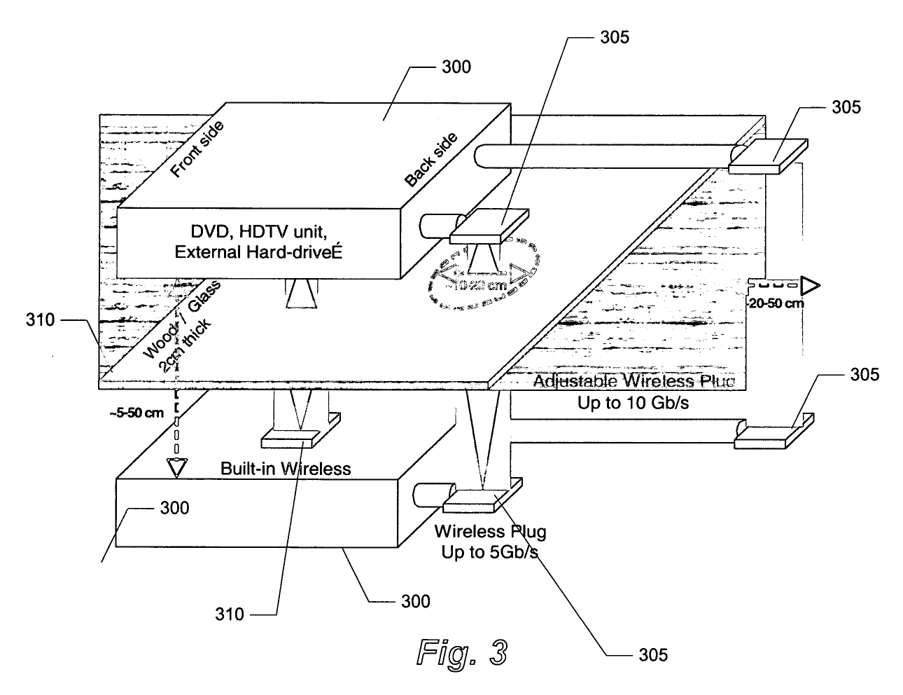

In an exemplary embodiment, the repeater assembly can be implemented in a unit-to-unit communication scheme, as illustrated in FIG. 3. For instance, a unit 300 can have either a built-in module 305, or a pluggable module 310. The built-in module 305 can come built-in the unit 300. Alternatively, the pluggable module 310 can be pluggable to a backside of the unit 300. Preferably, the backside of the unit 300 includes a dedicated digital interface. Consequently, through the use of the modules 305 or 310, communication wires can be reduced, or even in some cases eliminated.

In a preferred embodiment, the modules 305 and 310 of the repeater assembly can comprise at least two layers, a top layer 312 and a bottom layer 314. The top layer 312 is preferably comprised of liquid crystal polymer (LCP), while the bottom layer 314 is preferably comprised of FR4 (Fire Resistant 4). The top layer 312 and the bottom layer 314 are connected with an adhesive, preferably 3M-9713.

A patent application “Receiver Assembly and Method for Multi-Gigabit Wireless Systems” further describes this substrate layering. The patent application, having the same inventorship, was filed on the same date as the present application—31 Mar. 2006—the entire contents and substance is herein incorporated by reference.

Further, use of high gain, high directivity antennas with the modules 305 and 310 can enable data transmissions through a material 315, for instance, wood and/or glass, which can make-up or hold/secure the unit 300. Due to the high directivity of the antenna of the module 305 and 310, proximity alignment is preferred between different unit-to-unit wireless modules.

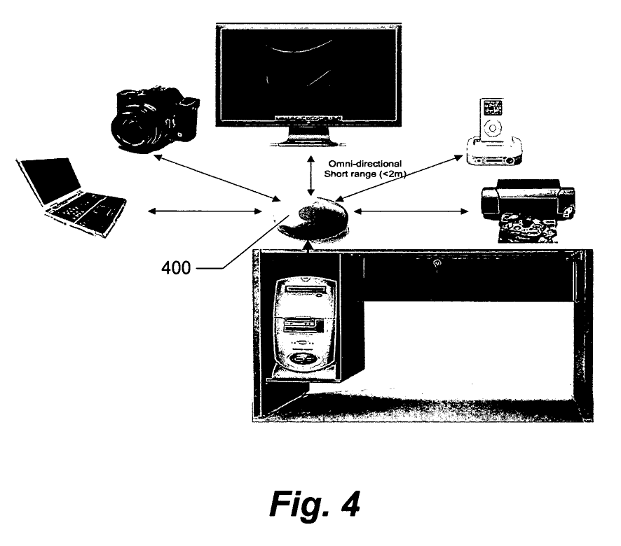

Indeed, this concept can be expanded, for in another embodiment, as illustrated in FIG. 4 a wireless repeater 400 can be used for unit to unit docking. The wireless repeater 400 can be located atop a table, or as illustrated, atop a desk. The wireless repeater 400 can then perform as a remote base station to address docking applications.

For instance, the wireless repeater 400 can communicate with a number of peripherals, for example, a laptop, a digital camera, a monitor, a mobile music device (MP3 player), a printer, a scanner, a desktop, and the like.

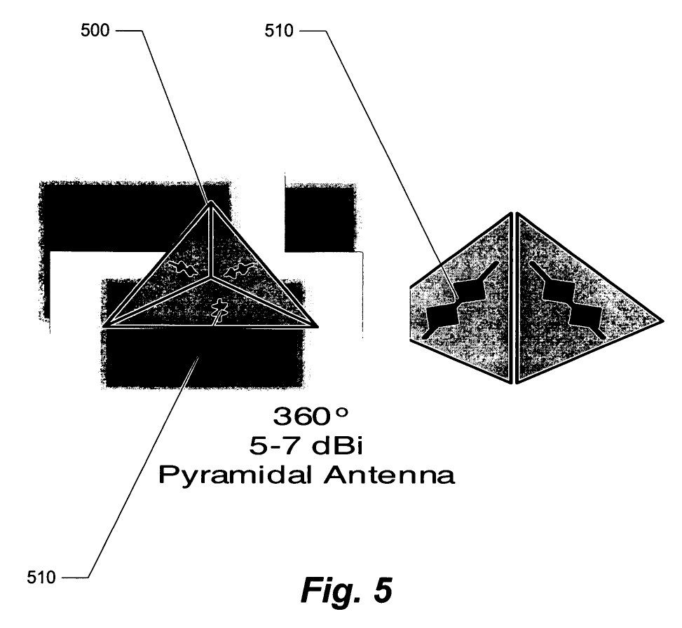

Referring now to FIG. 5, a pyramidal multi-sector antenna 500 for a 60 GHz wireless docking station is illustrated. The pyramidal antenna 500 can, preferably, cover 360 degrees in azimuth. Each sector of the multi-sector antenna 500 can support a low to medium gain, single patch antenna, or a 1 by 2 patch antenna array 510, depending on the required/desired coverage. Further, linear or circular polarization type antennas can be used. In a preferred embodiment, the dimension of the pyramidal antenna 500 is compatible with its integration, in a preferred volume of approximately 1.8 by 1.8 by 1.8 cubic centimeters.

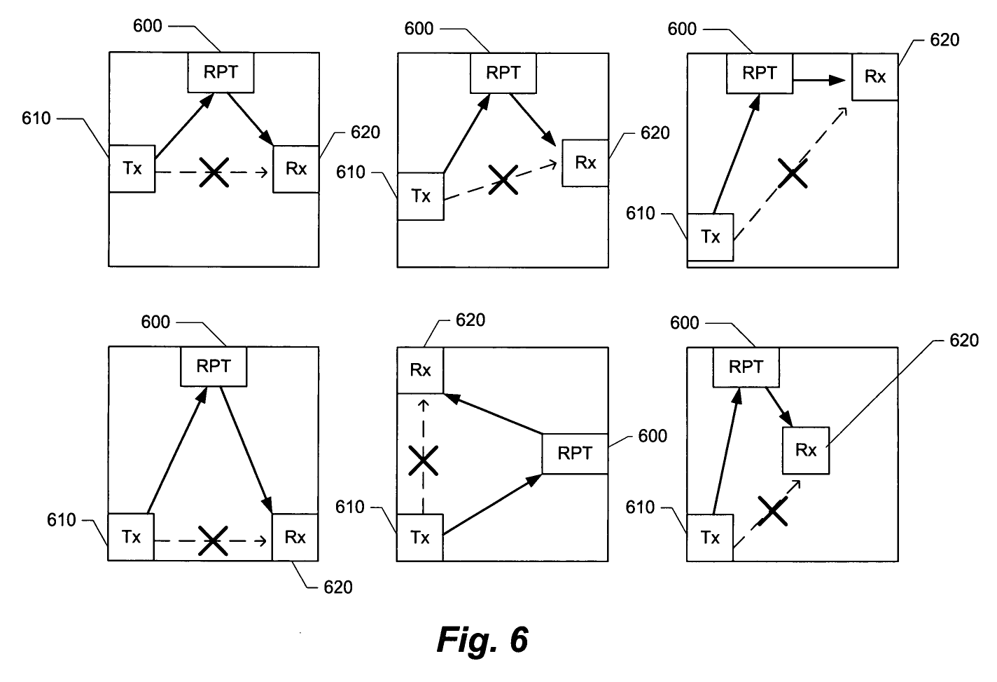

As described, one of the limitations of the ultra-high frequency, ultra-high speed communication is the line of sight limitation. FIG. 6 illustrates many examples of how a repeater 600 can be helpful to reduce the limitation of the line of sight. As shown, this limitation can be overcome by establishing path redundancy. The illustrations of FIG. 6 depict that within a single room, a single repeater 600 can create enough path redundancy in typical cases of obstructions. The use of two or more repeaters 600 can thus create an improved repeater system, wherein most, if not all, obstructions can be bypassed in order to transmit a signal from a transmitter 610 to a receiver 620.

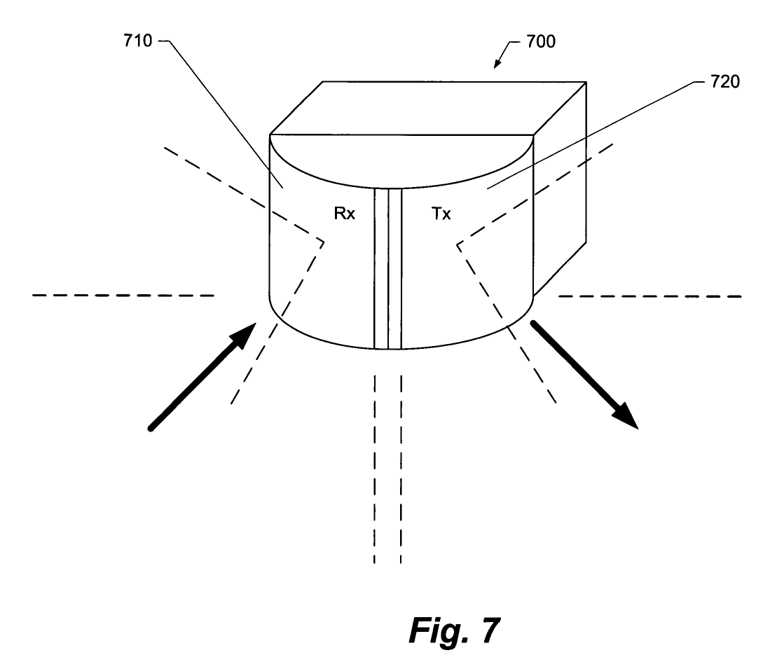

FIG. 7 illustrates an exemplary high level architecture of a receiver 710. This architecture comprises a plurality of transceivers (transmitter plus receiver) that can be arranged in a multi-sector configuration, depending on the desired coverage and the choice of an antenna. FIG. 7 illustrates a two-sector example.

The wireless repeater 700 of FIG. 7 can contain the receiver 710 and the transmitter 720. The receiver 720 and the transmitter 720 can be mounted on an automated mechanical scanning system, wherein the repeater 700 can automatically perform the optimum alignment with peripheral base stations. A range of the mechanical scanning is preferably in approximately 90 degrees in the azimuth, and the range of approximately 90 to 180 degrees in elevation, in order to establish and provide required coverage. Use of an omni-directional antenna for the receiver 710 can reduce the complexity, and even costs of the system, particularly if the repeater 700 is positioned in proximity to a transmitting base station to receive enough power and maintain an acceptable signal-to-noise ratio. Preferably, the repeater 700 is positioned approximately 2 meters from the ground to reduce shadowing and link interruption, and often to avoid human body obstructions.

Powering the wireless repeater presents a challenge. Since the repeater is wireless, the last thing a consumer wants with the wireless repeater is a power wire. Hence, the placement of wireless repeaters in communication with existing lighting systems of an indoor environment is advantageous. First, the use of an existing power supply suppresses the need for additional electric wiring and installation for the wireless repeater. Secondly, lighting systems are typically located above the ground, and therefore are suitable to easily establish a line-of-sight propagation path between different wireless nodes.

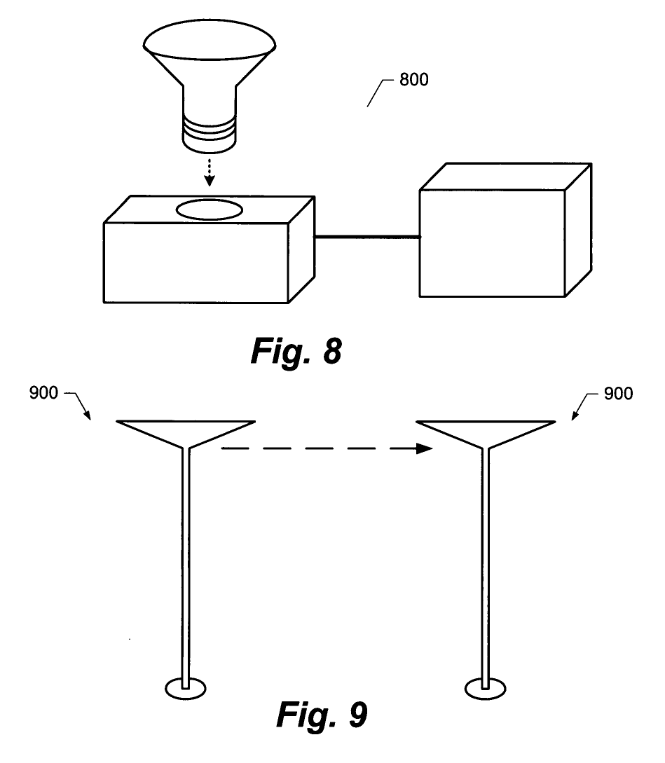

FIG. 8 illustrates a power adapter assembly 800 for a wireless repeater. In a preferred embodiment, the power adapter assembly 800 can enable a robust 60 GHz, 5 Gb/s wireless link, such as line of sight obstruction or through-wall link. A fundamental limitation for 60 GHz high-speed indoor communication systems is channel degradation, often due to shadowing effects occurring with a line of sight obstruction by human body. In severe shadowing conditions, macro-diversity can be applied by switching to a second access point as soon as the received signal drops below a sensitivity threshold. Also, the location and configuration (e.g., ceiling-mounted base antenna, corner-mounted base antenna, and/or wall-mounted base antenna) of the access points are considered critical parameters to insure pure channel performances.

Thus, because the wireless repeater can have a small form factor, it can be plugged into in an existing lighting system 900. This is illustrated in FIG. 9. In a preferred embodiment, the use of a power adaptor 800 can be adapted to receive a mounted 60 GHz wireless repeater, on many existing lighting systems. Additionally, new lighting systems can come installed with a wireless node, or a wireless repeater.

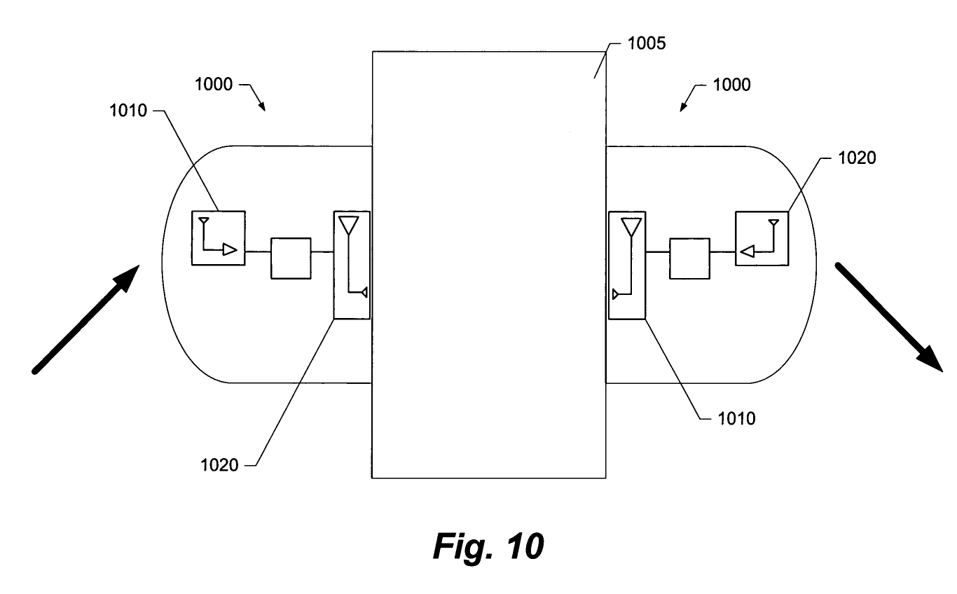

FIG. 10 illustrates a wireless repeater 1000 adapted to transmit through a wall 1005. For example, the wireless repeater 1000 can provide a through-wall (concrete, plasterboard, and the like) link, wherein transmitting a 60 GHz signal into an adjacent room, without a wired connection (electrical or optical). Preferably, each wireless through-wall repeater 1000 includes a receiver 1010 and a transmitter 1020.

The receiver/transmitter of the through-wall repeater 1000 can be mounted on an automated mechanical scanning system and/or feature a multi-sector topology to support sectorial coverage. Thus, the repeater 1000 can perform automatically the optimum alignment with proximity-located base stations, preferably within the same room of the repeater 1000. Preferably, the range of mechanical scanning can be approximately 180 degrees in azimuth, and in the range of approximately 90 to 180 degrees in elevation, in order to provide favorable coverage. Additionally, in a preferred embodiment, the repeater 1000 is positioned at least two meters above ground, wherein reducing shadowing and link interruption due to human body obstruction.

The receiver/transmitter dedicated for the through-wall repeater 1000 can be fixed on a backside of the repeater 1000, wherein being in direct contact with the wall. A two unit embodiment is preferably aligned on both sides of the wall, preferably within +/−5 cm, wherein providing a robust linkage.

The repeater 1000 can include the receiver 1010 (e.g., 60 GHz module), and the transmitter 1020 (e.g., 60 GHz module) implemented on the LCP-FR4 technology (as described above, and in the referenced patent application). An advanced version of the repeater module (see FIG. 2) includes a complete receiver and transmitter, and a buffer memory to compensate for severe link interruptions between the base station and the repeater.

The wireless repeaters described herein can preferably operate on a DC (direct current) power supply. For instance, the DC power supply can be a battery, a standard AC-DC plug, or an AC-DC adaptor that can be plugged on and derived the power from a light system.

While the invention has been disclosed in its preferred forms, it will be apparent to those skilled in the art that many modifications, additions, and deletions can be made therein without departing from the spirit and scope of the invention and its equivalents, as set forth in the following claims.

What is claimed is:

1. A wireless repeater assembly comprising:
a receiver for receiving wireless data communications, wherein the receiver comprises:
a receiving antenna for receiving analog signals;
a receiver filter adapted to enable frequencies of a predetermined range to pass onto a receiver amplifier; and
the receiver amplifier for boosting a signal emitted from the receiver filter;
a transmitter for transmitting wireless data communications, wherein the transmitter comprises:
a transmitter amplifier for boosting a signal coming from the receiver;
a transmitter filter adapted to enable frequencies of the predetermined range to pass onto the transmitting antenna; and
a transmitting antenna for transmitting signals from the repeater assembly; and
a hard wire connection between the receiver and the transmitter, wherein the receiver and the transmitter are in wired communication.

2. The wireless repeater assembly of claim 1, wherein the receiving antenna is tuned to receive at approximately 60 GHz, and the transmitting antenna is tuned to transmit at approximately 60 GHz.

3. The wireless repeater assembly of claim 2, wherein the receiving antenna comprises a high gain antenna, the receiver filter comprises a band-pass filter, and wherein the receiver amplifier comprises a low noise amplifier.

4. The wireless repeater assembly of claim 2, wherein the transmitter amplifier comprises a power amplifier, the transmitter filter comprises a band-pass filter, and wherein the transmitting antenna comprises a high gain antenna.

5. The wireless repeater assembly of claim 2, wherein the receiving antenna comprises a high gain antenna, the receiver filter comprises a band-pass filter, wherein the receiver amplifier comprises a low noise amplifier, wherein the transmitter amplifier comprises a power amplifier, the transmitter filter comprises a band-pass filter, and wherein the transmitting antenna comprises a high gain antenna.

6. The wireless repeater assembly of claim 2, wherein the wireless repeater assembly can transmit through a wall to a second wireless repeater assembly, and wherein the wireless repeater assembly and the second wireless repeater assembly are in proximity to each other on opposing sides of the wall.

7. The wireless repeater assembly of claim 5, further comprising a buffer memory positioned between the receiver and the transmitter for securing data.

8. A wireless repeater assembly of claim 7, wherein the receiver further comprises an analog-to-digital converter, and wherein the transmitter further comprises a digital-to-analog converter.

9. The wireless repeater assembly of claim 6, wherein the wireless repeater assembly is in communication with a power adapter of a light source, and wherein the wireless repeater assembly obtains operating power from the power adapter.

10. The wireless repeater assembly of claim 7, wherein the wireless repeater assembly is positioned at least two meters above a ground.

111. The wireless repeater assembly of claim 7, wherein the wireless repeater can scan approximately 90 degrees in an azimuth, and in the range of approximately 90 to 180 degrees in a elevation for analog signals operating at approximately 60 GHz within five meters of the wireless repeater assembly.

122. The wireless repeater assembly of claim 7, wherein the wireless repeater assembly is powered with direct current.

13. A wireless repeater assembly comprising:
a top layer includes liquid crystal polymer, and the top layer defining a top layer cavity; and
a bottom layer having fire resistant 4.
